(19) United States
(12) Patent Application Publication
(10) Pub. No.: US 2011/0021342 A1
(43) Pub. Date: Jan. 27, 2011

(54) Method for Making RU-SE and RU-SE-W Nanometer Catalyst

(75) Inventors: Chun-Ching CHIEN, Longtan Shiang (TW); Shean-Du Chiou, Longtan Shiang (TW); Su-Hsine Lin, Longtan Shiang (TW); Ning-Yih Hsu, Longtan Shiang (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 12/140,834

(22) Filed: Jun. 17, 2008

(51) Int. Cl. B01J 21/18; H01M 4/88; B01J 37/08; B01J 37/04; B01J 37/06; B01J 23/46

(52) U.S. Cl. 502/101; 502/185; 977/842

(57) ABSTRACT

A method is disclosed for making Ru—Se and Ru—Se—W catalyst. In the method, carrier is processed with strong acid and poured into first ethylene glycol solution. Ultra-sonication and high-speed stirring are conducted on the first ethylene glycol solution, thus forming carbon paste. The carbon paste is mixed with second ethylene glycol solution containing at least one nanometer catalyst precursor and an additive. High-speed stirring is conducted to form mixture. The mixture is heated so that Ru—Se catalyst is reduced. The mixture is filtered to separate the carrier. Then, the carrier is washed with de-ionized water. Conducting drying and hydrogen reduction are conducted to make the Ru—Se catalyst on the carrier.

### FIELD OF THE INVENTION

The present invention relates to a method for making Ru—Se and Ru—Se—W nanometer catalyst.

### DESCRIPTION OF THE RELATED ARTS

Fuel cells exhibit advantages such as high conversion rates, low pollution and fast supply of fuel. Fuel cells are a promising solution to demands for energy and protection of the environment. Direct methanol fuel cells and proton exchange membrane fuel cells are the most promising among the fuel cells because they provide high energy densities, high conversion rates and electricity for long periods, and involves simple structures and lightest weights, and can be carried conveniently. They can be used, instead of conventional laptop computers, cell phones and other electronic devices.

There have been prototypes of electric vehicles. Commercial electric vehicles however still have a long way to go. The bottleneck of the commercialization of electric vehicles is the limited supply of Pt, which is used as electrode catalyst in fuel cells for powering electric vehicles. Pt cannot be synthesized and is expensive. Hence, it is impractical to commercialize fuel cells. There is a need for materials that can be used instead of Pt.

The present invention is therefore intended to obviate or at least alleviate the problems encountered in prior art.

### SUMMARY OF THE INVENTION

It is the primary objective of the present invention to make Ru—Se series nanometer catalyst for use in fuel cells.

According to the present invention, carbon nano-tubes (“CNT”) are used as carrier. The carrier is processed with strong acid and poured into first ethylene glycol (“EG”) solution. Ultra-sonication and high-speed stirring are conducted on the first EG solution to form carbon paste. The carbon paste is mixed with second EG solution containing at least one nanometer catalyst precursor and an additive. High-speed stirring is conducted to form mixture. The mixture is heated so that the reduction of Ru—Se catalyst is conducted. The mixture is filtered so that the CNT are separated. The CNT are washed with de-ionized water and then dried in an oven or drying box. Finally, hydrogen reduction is conducted on the dried CNT to make the Ru—Se catalyst on the CNT.

In a first aspect of the present invention, CNT are used as carrier. The carrier is processed with strong acid and poured into first EG solution. Ultrasonication and high-speed stirring are conducted on the first EG solution to form carbon paste. The carbon paste is mixed with second EG solution containing selenious acid as a nanometer catalyst precursor and sodium bi-sulfite solution as an additive. High-speed stirring is conducted to form mixture. Via microwave irradiation or with an oven or electric heater, the mixture is heated so that Ru—Se catalyst is reduced. The mixture is filtered so that the CNT are separated. The CNT are washed with de-ionized water and then dried in an oven or drying box at 100 degrees Celsius. The dried CNT are disposed in a hydrogen oven for high-temperature reduction to make the Ru—Se catalyst on the CNT.

In a second aspect of the present invention, CNT are used as carrier. The carrier is processed with strong acid and poured into first EG solution. Ultrasonication and high-speed stirring are conducted on the first EG solution to form carbon paste. The carbon paste is mixed with second EG solution containing ruthenium trichloride and tungsten hexachioride as nanometer catalyst precursors and sodium bi-sulfite solution as an additive. High-speed stirring is conducted to form mixture. Via microwave irradiation or with an oven or an electric heater, heating is conducted on the mixture to reduce Ru—Se catalyst. The mixture is filtered so that the CNT are separated. The CNT are washed with de-ionized water and then dried in an oven or drying box at 100 degrees Celsius. The dried CNT is disposed in a hydrogen oven for high-temperature reduction to make the Ru—Se catalyst on the CNT.

In a third aspect of the present invention, CNT are used as carrier. The carrier is processed with strong acid and poured into first EG solution. Ultrasonication and high-speed stirring are conducted on the first EG solution to form carbon paste. The carbon paste is mixed with second EG solution containing selenious acid as a nanometer catalyst precursor and sodium bora-hydride solution as an additive. High-speed stirring is conducted to form mixture. Via microwave irradiation or with an oven or electric heater, the mixture is heated so that Ru—Se catalyst is reduced. The mixture is filtered so that the CNT are separated. The CNT are washed with de-ionized water and then dried in a vacuum oven or drying box at 100 degrees Celsius. The dried CNT are disposed in a hydrogen oven to make the Ru—Se catalyst on the CNT.

In a fourth aspect of the present invention, CNT are used as carrier. The carrier is processed with strong acid and poured into first EG solution. Ultrasonication and high-speed stirring are conducted on the first EG solution to form carbon paste. The carbon paste is mixed with second EG solution containing ruthenium trichloride and tungsten hexachloride as nanometer catalyst precursors and sodium borohydride solution as an additive. High-speed stirring is conducted to form mixture. Via microwave irradiation or with an oven or electric heater, the mixture is heated so that Ru—Se catalyst is reduced. The mixture is filtered so that the CNT are separated. The CNT are washed with de-ionized water and then dried in a vacuum oven or drying box at 100 degrees Celsius. The dried CNT are disposed in a hydrogen oven for reduction, thus making the Ru—Se catalyst on the CNT.

Other objectives, advantages and features of the present invention will become apparent from the following description referring to the attached drawings.

### BRIEF DESCRIPTIONS OF THE DRAWINGS

The present invention will be described via the detailed illustration of embodiments referring to the drawings.

FIG. 1 is a flow chart of a method for making Ru—Se/CNT catalyst according to the preferred embodiment of the present invention.

FIG. 2 is a chart for showing the discharge curves of a single fuel cell using the Ru—Se/CNT catalyst made in the method shown in FIG. 1.

FIG. 3 is a chart for showing the power density of the single fuel cell shown in FIG. 1 relative to time.

FIG. 4 is a photograph of the Ru—Se/CNT catalyst made in the method shown in FIG. 1 with taken an electronic microscope.

### DESCRIPTION OF THE PREFERRED EMBODIMENT

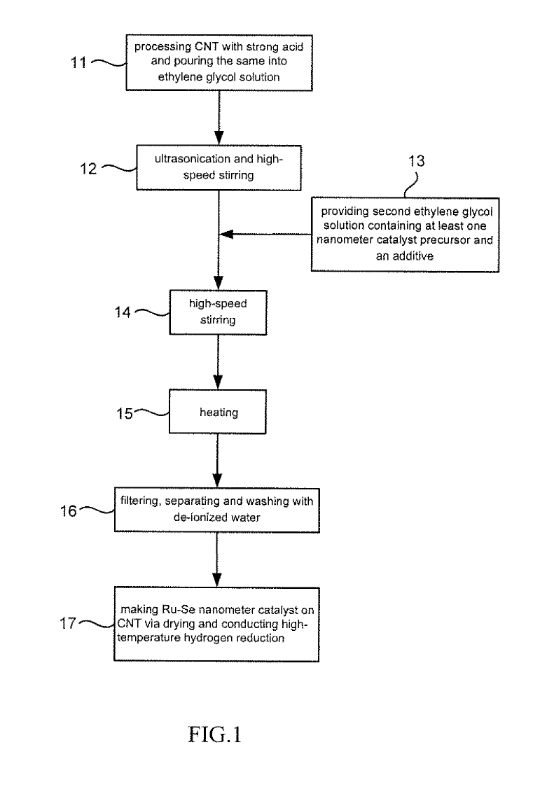

Referring to FIG. 1, there is shown a method for making Ru—Se and Ru—Se—W catalyst according to the present invention.

At 11, carrier is processed with strong acid and poured into first ethylene glycol (“EG”) solution. The carrier is preferably carbon nano-tube (“CNT”) powder.

At 12, ultra-sonication and high-speed stirring are conducted on the first EG solution, thus forming carbon paste.

At 13, the carbon paste is mixed with second EG solution which contains at least one nanometer catalyst precursor and an additive. The additive may be sodium bi-sulfite or sodium borohydride solution.

At 14, high-speed stirring is conducted, thus forming mixture.

At 15, the mixture is heated so that Ru—Se catalyst is reduced. The heating may be conducted via microwave irradiation or with an oven or electric heater.

At 16, the mixture is filtered so that the CNT are separated. Then, the CNT are washed with de-ionized water.

At 17, drying and hydrogen reduction are conducted. Thus, there is made the Ru—Se catalyst using the CNT as the carrier. The drying may be conducted via an oven or a drying box.

In the above-mentioned process, the Ru—Se nanometer catalyst uses the CNT as the carrier. Since the size of the Ru—Se nanometer catalyst is in the order of nanometer, the activity of the Ru—Se nanometer catalyst is high so that the Ru—Se nanometer catalyst can be used instead of Pt that is expensive. The Ru—Se nanometer catalyst can be used in direct methanol fuel cells (“DMFC”) and proton exchange membrane fuel cells (“PEMFC”) for the catalytic reaction of organic compounds such as the gas phase dehydrogenation and gas phase hydrogenation of simple molecules and the production hydrogen via molecule rearrangement.

A method according to a first embodiment of the present invention will be described. At 11, carrier is processed with strong acid and poured into first EG solution. The carrier is CNT powder.

At 12, ultrasonication and high-speed stirring are conducted on the first EG solution to form carbon paste. The ultrasonication lasts for 5 to 15 minutes. The high-speed stirring lasts for 20 to 40 minutes.

At 13, the carbon paste is mixed with second EG solution containing at least one nanometer catalyst precursor and an additive. Selenious acid is used as the nanometer catalyst precursor while sodium bi-sulfite solution is used as the additive.

At 14, high-speed stirring is conducted to form mixture. The high-speed stirring lasts for 25 to 35 minutes.

At 15, the mixture is heated via microwave irradiation so that Ru—Se catalyst is reduced. The heating proceeds at 110 to 150 degrees Celsius and lasts for 25 to 35 minutes. The heating may alternatively be done with an oven or electric heater.

At 16, the mixture is filtered after the reduction so that the CNT are separated. Then, the CNT are washed with de-ionized water.

At 17, the CNT are dried in a vacuum oven or drying box at 100 degrees Celsius. The dried CNT are disposed in a hydrogen oven at 100 to 400 degrees Celsius for 1 hour so that the reduction is complete.

A method according to a second embodiment of the present invention will be described. At 11, carrier is processed with strong acid and poured into first EG solution. The carrier is CNT powder.

At 12, ultrasonication and high-speed stirring are conducted on the first EG solution to form carbon paste. The ultrasonication lasts for 5 to 15 minutes. The high-speed stirring lasts for 20 to 40 minutes.

At 13, the carbon paste is mixed with second EG solution containing at least one nanometer catalyst precursor and an additive. Ruthenium trichloride and tungsten hexa chloride are used as the nanometer catalyst precursors while sodium bi-sulfite solution is used as the additive.

At 14, high-speed stirring is conducted to form mixture. The high-speed stirring lasts for 25 to 35 minutes.

At 15, the mixture is heated via microwave irradiation. The heating proceeds at 110 to 150 degrees Celsius and lasts for 25 to 35 minutes. The heating may alternatively be done with an oven or electric heater.

At 16, the mixture is filtered after the reduction so that the CNT are separated. Then, the CNT are washed with de-ionized water.

At 17, the CNT are dried in a vacuum oven or drying box at 100 degrees Celsius. The dried CNT are disposed in a hydrogen oven at 100 to 400 degrees Celsius for 1 hour so that the reduction is complete.

A method according to a third embodiment of the present invention will be described. At 11, carrier is processed with strong acid and poured into first EG solution. The carrier is CNT powder.

At 12, ultra-sonication and high-speed stirring are conducted on the first EG solution to form carbon paste. The ultrasonication lasts for 5 to 15 minutes. The high-speed stirring lasts for 20 to 40 minutes.

At 13, the carbon paste is mixed with second EG solution containing at least one nanometer catalyst precursor and an additive. Selenious acid is used as the nanometer catalyst precursor while sodium boro-hydride solution is used as the additive.

At 14, high-speed stirring is conducted to form mixture. The high-speed stirring lasts for 25 to 35 minutes.

At 15, the mixture is heated via microwave irradiation. The heating proceeds at 110 to 150 degrees Celsius and lasts for 25 to 35 minutes. The heating may alternatively be done with an oven or electric heater.

At 16, the mixture is filtered so that the CNT are separated. Then, the CNT are washed with de-ionized water.

At 17, the CNT are dried in a vacuum oven or drying box at 100 degrees Celsius. The dried CNT are disposed in a hydrogen oven at 100 to 400 degrees Celsius for 1 hour so that the reduction is complete.

A method according to a fourth embodiment of the present invention will be described. At 11, carrier is processed with strong acid and poured into first EG solution. The carrier is CNT powder.

At 12, ultrasonication and high-speed stirring are conducted on the first EG solution to form carbon paste. The ultrasonication lasts for 5 to 15 minutes. The high-speed stirring lasts for 20 to 40 minutes.

At 13, the carbon paste is mixed with second EG solution containing at least one precursor and an additive. Ruthenium trichloride and tungsten hexachloride are used as the nanometer catalyst precursors while sodium borohydride solution is used as the additive.

At 14, high-speed stirring is conducted to form mixture. The high-speed stirring lasts for 25 to 35 minutes.

At 15, the mixture is heated via microwave irradiation. The heating proceeds at 110 to 150 degrees Celsius and lasts for 25 to 35 minutes. The heating may alternatively be done with an oven or electric heater.

At 16, the mixture is filtered so that the CNT are separated. Then, the CNT are washed with de-ionized water.

At 17, the CNT are dried in a vacuum oven or drying box at 100 degrees Celsius. The dried CNT are disposed in a hydrogen oven at 100 to 400 degrees Celsius for 1 hour so that the reduction is complete.

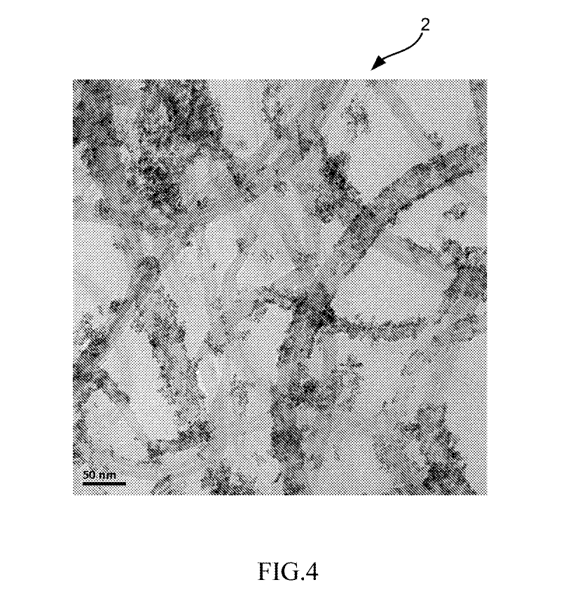

Referring to FIG. 4, there is shown a photograph of the Ru—Se-CNT carrier taken with an electron microscope.

The Ru—Se catalyst 2 uses the CNT as the carrier. The diameters of the CNT are ten to hundreds of nanometers. The CNT tangle with one another and form a net-like structure with gaps for receiving the particles of the Ru—Se catalyst. When used in a fuel cell, fuel molecules and products of the reaction go through the gaps between the CNT so that the catalysis continues. The CNT are chemically idle and cannot be solved in water or methanol solution, and survive 300 degrees Celsius without reaction or decomposition.

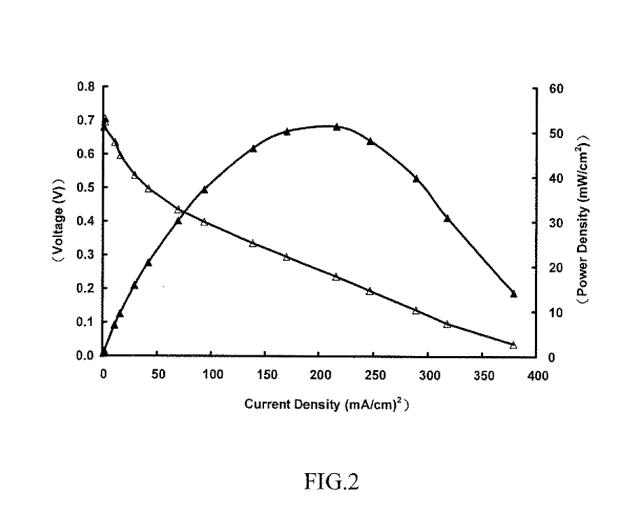

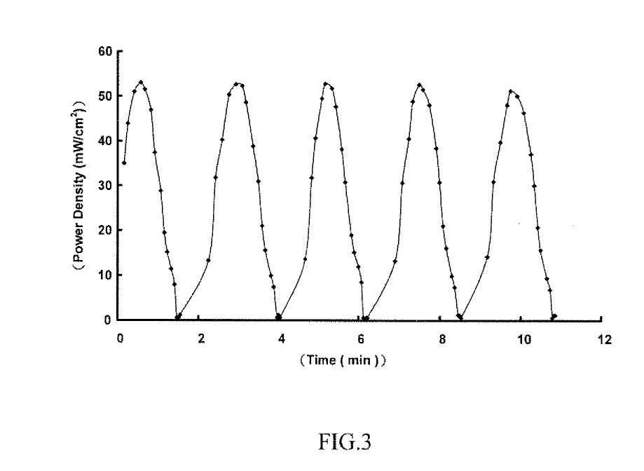

Referring to FIGS. 2 and 3, the Ru—Se-CNT is used as the cathode catalyst of a membrane electrode assembly of a DMFC. Test is run on a single cell with an area of 25 cm2. The anode catalyst of the DMFC is Pt—Pu—Ir/CNT of mg/cm2. The membrane is Nafion117. The cathode catalyst of the DMFC is the Ru—Se-CNT of 4 mg/cm2. Under 1 atm, methanol solution flows at 10 mL/min near the anode. Oxygen travels at 200 mL/min near the cathode.

According to the present invention, the Ru—Se nanometer catalyst uses the CNT as the carrier. Since the size of the Ru—Se nanometer catalyst is in the order of nanometer, the activity of the Ru—Se nanometer catalyst is high. Therefore, the Ru—Se nanometer catalyst can be used in fuel cells and the resultant fuel cells exhibit excellent performance.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A method for making Ru—Se and Ru—Se—W catalyst comprising the steps of:
(A) processing carrier with strong acid and poured into first ethylene glycol solution;
(B) conducting ultra-sonication and high-speed stirring on the solution, thus forming carbon paste;
(C) mixing the carbon paste with second ethylene glycol solution containing at least one nanometer catalyst precursor and an additive;
(D) conducting high-speed stirring, thus forming mixture;
(E) heating the mixture for reducing Ru—Se catalyst;
(F) filtering the mixture to separate the carrier and washing the carrier with de-ionized water; and
(G) conducting drying and hydrogen reduction to make the Ru—Se catalyst on the carrier.

2. The method according to claim 1, wherein selenious acid is used as the nanometer catalyst precursor.

3. The method according to claim 1, wherein ruthenium trichloride and tungsten hexachloride are used as the nanometer catalyst precursors.

4. The method according to claim wherein the additive is sodium bisulfite.

5. The method according to claim 1, wherein the additive is sodium borohydride.

6. The method according to claim 1, wherein the heating of step (E) is conducted via microwave irradiation.

7. The method according to claim 1, wherein the heating of step (E) is conducted with an oven.

8. The method according to claim 1, wherein the heating of step (E) is conducted with an electric heater.

9. The method according to claim 1, wherein the oven used of step (C) generates vacuum.

10. The method according to claim 1, wherein the oven used of step (g) operates at 100 degrees Celsius.

11. The method according to claim 1, wherein the Ru—Se series catalyst is used in direct methanol fuel cells.

12. The method according to claim 1, wherein the Ru—Se series catalyst is used in proton exchange fuel cells.

13. The method according to claim 1, wherein the Ru—Se series catalyst can be used for the catalysis of organic compounds and the gas phase dehydrogenation of simple molecules.

14. The method according to claim 1, wherein the Ru—Se series catalyst can be used for the catalysis of organic compounds and hydrogenation.

15. The method according to claim 1, wherein the Ru—Se series catalyst can be used for the catalysis of organic compounds and molecule rearrangement.

16. The method according to claim wherein the hydrogen reduction of step (G) takes place at 100 to 400 degrees Celsius.

17. The method according to claim 1, wherein the hydrogen reduction of step (G) lasts no longer than 1 hour.

18. The method according to claim 1, wherein the drying of step (G) is conducted with an oven.

19. The method according to claim 1, wherein the drying of step (G) is conducted with a drying box.

20. The method according to claim 1, wherein the carrier is carbon nano-tube powder.
